(19) United States
(12) Patent Application Publication
(10) Pub. No.: US 2010/0252128 A1
(43) Pub. Date: Oct. 7, 2010

(54) MICROFLUIDIC DEVICE

(76) Inventors: Hai-Qing Gong, Singapore (SG); Kam Man Hui, Singapore (SG); Hao-Bing Liu, Singapore (SG)

Correspondence Address: MAIER & MAIER, PLLC, 1000 DUKE STREET, ALEXANDRIA, VA, 22314, US

(21) Appl. No.: 12/743,828

(22) PCT Filed: Dec. 4, 2008
(86) PCT No.: PCT/SG08/00464

§ 371 Date: May 20, 2010

(30) Foreign Application Priority Data
Dec. 17, 2007 (AU) 20077906784

(51) Int. Cl. F16L 41/00

(52) U.S. Cl. 137/561 A

(57) ABSTRACT

The present invention provides a microfluidic device comprising a plurality of wells, each of which may be substantially filled with a liquid without either the need for expensive individual sample loading or the requirement to isolate individual wells to prevent cross contamination and sample evaporation. A base member (2) comprises a plurality of wells (4) in the form of an array, an inlet channel (6) and three outlets (8).

### TECHNICAL FIELD

The invention relates to microfluidic devices, and systems and methods for use of such devices. The invention is particularly suitable for use in Polymerase Chain Reaction (PCR) applications and it will be convenient to describe the invention with reference to that application. However it is to be understood that the devices, systems, and methods of the invention are suitable in other applications.

### BACKGROUND ART

The completion of the Human Genome Project triggered a rapid development of high-throughput platforms for parallel genomic assays. Currently, two types of DNA microarrays are widely used as platforms for highly parallel genomic assays: microarrays for genome-wide expression profiling and microarrays for single nucleotide polymorphism (SNP) detection and genotyping. The validation of microarray results remains a desirable step due to non-standard methods of data analysis and interpretation. Quantitative reverse transcription PCR (qRT-PCR) is often used as an alternative technology to validate gene expression profiling studies. Moreover, the sensitivity and specificity of microarray technology is low and the multiple steps involved in this technology introduce variability in the results when compared to real-time PCR. For SNP detection and genotyping, the PCR process is used to amplify the samples before they are analysed by melting curve technique or by hybridization to oligonucleotide probes. For gene expression profiling, it is desirable to integrate the quantitative, sensitive capabilities of real-time PCR with high-throughput capability of a microarray as a single platform for highly parallel genomic assays. In addition to the microarray technology for parallel analyses of multiple gene targets, a number of platforms have been developed to integrate PCR with microarray techniques. Most of these platforms combine solid-phase PCR with microarray platform. However, studies show that solid-phase PCR is less efficient than solution-phase PCR.

Immense efforts have been made to develop PCR-based biochips for the rapid, high-throughput analysis of a large number of genes. Such biochips (chips) generally contain a plurality of wells, each capable of retaining a solution. Problems associated with the devices developed to date include: the tedious manual loading of the PCR sample into the individual reaction wells of the PCR chip; the substantial expense of liquid-dispensing robots for loading the wells with solutions; or problems associated with the immobilization of the nucleotide primers within a gel matrix. Furthermore, it is desirable that high-throughput PCR chips are cheap to fabricate, are disposable and maintain a uniform temperature throughout a large reaction array. In addition, a simple and cheap sample loading and reaction well sealing method is desired to reduce the cost of performing operations with the chip.

There are two types of configurations for high-throughput PCR chips. The first type consists of an array or matrix of fluidic micro chambers. Such a configuration employs microfluidic channel networks for loading liquid sample into an array of chambers with one pipette operation. Typically, to each chamber is connected an inlet channel for sample loading and an outlet channel for air-venting. It is complicated, however, to isolate and seal all the chambers using mechanical valves because the inlet and outlet channels of each of the microchambers have to be sealed to prevent PCR mixture evaporation during thermocycling and to prevent primer pair cross-contamination. In addition, the channels in such configuration occupy space on the chip and limit the density of chambers on the chip. The second type of high-throughput PCR chip consists of a miniaturized well-plate. In this type of configuration, a high density of microwells is possible wherein the microwells can be isolated and sealed using a thin cover or sealant on top of the wells. Sample loading and other liquid handling operations, however, are achieved using high precision robots, which are expensive and require skilled operators.

Recently a disposable polydimethylsiloxane (PDMS) chip containing three wells has been reported (Xiang, Q.; Xu, B.; Fu, R.; Li, D. Biomed Microdevices 2005, 7, 273-279). The chip was utilised for PCR, wherein the PCR mixture was manually loaded into each of the wells (being 0.9 μL in volume) whereupon the wells were subsequently covered with mineral oil to prevent evaporation.

Another device that has been developed for PCR (Chaudhari, A. M.; Woudenberg, T. M.; Albin, M.; Goodson, K. E. Journal of Microelectromechanical Systems 1998, 7, 345-355) utilises a microfabricated 18-vessel array, wherein the microchambers are sealed with a glass cover using a PCR-compatible acrylic-based adhesive tape.

Leamon et al. reported a novel PicoTiterPlate™ platform in which 300,000 vessels with a reaction volume of 39.5 pL each, were simultaneously utilised for solid-phase asymmetric PCR (Leamon, J. H.; Lee, W. L.; Tartaro, K. R.; Lanza, J. R.; Sarkis, G. J.; deWinter, A. D.; Berka, J.; Lobman, K. L. Electrophoresis 2003, 24, 3769-3777).

Few researchers have used microfluidic liquid distribution for performing PCR on a chip. Among them, Mathies et al. (Lagally, E.; Simpson, P. C.; Mathies, R. A. Sensors and Actuators B 2000, 63, 138-146) demonstrated that multiple PCR could be performed on a chip with a microfluidic distribution of a PCR mixture using a mechanical valve array for sample loading and well sealing. Quake et al. applied microfluidic technology to distribute 2 μL quantities of PCR mixture among 400 independent reactors in a PDMS chip, using 2,860 integrated hydraulic valves and pneumatic pumps (Liu, J.; Hansen, C.; Quake, S. R. Anal Chem 2003, 75, 4718-4723). The same technology is also described in US patent 20030138829

There is a need for an alternate technology which allows a number of closely spaced reaction vessels to be rapidly filled and sealed without the need for expensive materials and equipment.

### DISCLOSURE OF INVENTION

The present invention provides a microfluidic device comprising a plurality of wells, each of which may be substantially filled with a liquid without either the need for expensive individual sample loading or the requirement to isolate and seal individual wells to prevent cross-contamination and sample evaporation.

In one aspect the invention provides a device for distributing a liquid into a plurality of wells, the device comprising:

a) a base having a plurality of wells;

b) a cover overlying the base so as to define a headspace above the wells into which the wells open;

c) at least one inlet for feeding the liquid into the headspace for distribution of the liquid into the wells; and

e) at least one outlet for fluid communication with the headspace for removal of excess liquid from the headspace and/or for fluid communication with the headspace for application of a reduced pressure to the headspace.

In another aspect, the invention provides a system for distributing a liquid into a plurality of wells comprising:

a) a device as described above;

b) a reservoir containing liquid to be distributed, the reservoir being connected to the at least one inlet via a valve means for controlling the flow of liquid from the reservoir to the headspace; and

c) a means for applying reduced pressure to the at least one outlet.

In another aspect, the invention provides a method of using a device or system as described above comprising applying reduced pressure to the or each outlet such that liquid is drawn through the or each inlet into the headspace for distribution into the wells.

In another aspect, the invention provides a method of using the system of the present invention comprising the steps of:

a) applying reduced pressure to the at least one outlet such that the pressure within the headspace and wells of the device is less than the pressure of the liquid at the outlet of the reservoir;

b) opening the valve means such that the liquid within the reservoir exits the reservoir and enters the headspace and wells of the device;

c) isolating the means of reducing the pressure within the headspace and wells of the device from fluid communication with the headspace and wells of the device.

### BEST MODE FOR CARRYING OUT THE INVENTION

The devices, systems (apparatus) and methods of the present invention provide means for distributing liquids into a plurality of wells, isolating and sealing the wells. The present invention is especially suited for application to immunoassays, cell-based assays and the Polymerase Chain Reaction (PCR), although it is not limited to these applications.

As used herein, the term ‘well’ has the standard meaning in the art. In general terms, a well may be a depression made to hold liquid. The depression may be formed by removal of a part of a solid mass (such as in etching or sculpting a depression out of a solid shape). The depression may be formed by moulding a curable liquid to produce a solid mass possessing the depression (such as in the use of a pre-fabricated die to produce a complementary shape). The shape of a well may be defined by two or more faces. Examples of such shapes include cones, pyramids, prisms and truncated variants thereof. In all cases the shape defining a well possesses an aperture through which liquid and/or gas may enter and/or exit the well. The aperture for the wells may be rectangular (including square) or circular in shape. Preferably, and where appropriate, the aperture is greater in dimension than the lower surface of the well. Preferably the wells are shaped as a truncated square pyramid wherein the largest square face provides an opening for the well. The devices, systems and methods of the present invention are suited to low-, medium- and high-density well applications. Low-density applications typically use less than 10 reaction wells per chip. Medium-density applications typically use between about 10 and about 100 reaction wells per chip. High-density applications typically use more than 100 reaction wells per chip. The devices, systems and methods of the present invention preferably utilise wells with a volume each of between about 0.1 pL and about 3 mL. Preferably the wells are distributed evenly across a space, in the form of a grid or ordered array.

Whilst the devices of the present invention may be single- or multi-use in design, they are especially suited to single-use applications. Preferably the devices of the present invention are constructed of materials that are relatively inexpensive, and are substantially inert to the materials into which they come in contact. Materials which may be polymerised, cross-linked and/or cured in the presence of a complementary shape, mould or die are particularly well-suited for construction of the base-members of the invention. Examples of such materials include urethane, latex, vinyl and silicone. In certain applications, such as fluorescence detection based assays, it is preferable to use plastic materials that have low auto-fluorescence to reduce the fluorescence noise which may interfere with the fluorescence from the mixtures in the wells. The present invention contemplates that the devices, systems and methods described herein may be used in assays (or in preparation for performing assays) that may use fluorescence detection based methods. An example of such an assay is real-time quantitative PCR amplification of nucleic acid material. In one embodiment of such an assay, light from a source (which may have been filtered using a band-pass filter to provide light within a narrow range of wavelengths) enters the wells of the device, wherein may be located one or more substances that are sensitive to light of that range of wavelengths. The substance(s) may fluoresce and emit light of a different range of wavelengths to that range of wavelengths to which it is sensitive. The emitted light (which may have been filtered using a band-pass filter to provide a narrow range of wavelengths) may be detected by a detector means. The detector means may be located inside the device or outside the device. Accordingly the devices of the present invention are preferably constructed so as to allow light to enter the wells of the device. Even more preferably, the devices of the present invention are constructed so as to allow light to enter the wells of the device and also exit the wells of the device. In preferred embodiments, the device provides a means for allowing light to enter the wells of the device and a means for allowing light to exit the wells of the device. An example of such a means is a cover that is substantially transparent to certain wavelengths of light. A specific example of such a means is a glass cover plate, wherein the glass preferably has low-autofluorescence. An example of a fluorescence detection based assay is one that uses source light (which has been passed through a band-pass filter) of wavelengths in the range of 465 nm to 495 nm, and uses a detector means capable of detecting emitted light (which has been passed through a band-pass filter) of wavelengths in the range of 515 nm to 555 nm. In those embodiments of the present invention wherein the headspace of the device has been sealed with a substance (such as a cured liquid pre-polymer) it is preferable that the sealant also allows transmission of light into, and out of the wells. Examples of plastics which may be suitable for use in the devices and systems of the present invention are polypropylene (PP), polycarbonate (PC), polymethylmethacrylate (PMMA) and certain silicone materials. An especially preferred plastic for use in the devices, systems and methods of the invention is polydimethylsiloxane (PDMS). Complementary moulds suitable for the fabrication of components of the present invention, in particular the base member, are preferably made using a micro-machining technique. An example of such a technique is micro Electrical Discharge Machining (EDM). An example of a material that may be used as a complementary mould is stainless steel.

The device itself may be constructed from more than one material. In this respect, the properties of one material may lend themselves to that material being used to form certain components of the device. Examples of properties that make one material suitable for use in a particular component include flexibility, surface functionality, hydrophilicity/hydrophobicity, ease of casting and cost of the material. Whilst certain materials may be selected to provide appropriate surface functionality for reaction with a substrate, preferably all components are substantially inert to the chemicals/reaction mixtures with which they come into contact. Preferably, the materials used in the construction of the devices and systems of the present invention will be compatible with the conditions of the chosen application. For example, the technique of PCR requires efficient thermal transfer between a heat source/sink and each reaction well. Accordingly for this application the materials should preferably be able to conduct heat efficiently and withstand thermal cycling without undergoing substantial deformation or melting. The properties of a given material may be modified through selection of thickness, etc. In these respects, PDMS represents a suitable and preferred material. Preferred materials for forming rigid components of the device include metal, glass and ceramic. Glass is an especially preferred rigid component for use in the devices, systems and methods of the present invention. More preferably, where a device of the present invention comprises two or more materials, the components are connected using a binding material. Preferably the material used to bind the components is applied in substantially liquid form so as to bind the two components evenly across a surface, and subsequently undergoes a transformation rendering it solid. An example of a method of application of such a binding agent is spin-coating. Where the device is made of glass and PDMS, the components may be bound using liquid PDMS pre-polymer. In this regard, the curing of the pre-polymer forms a semi-permanent bond between the two components. In preferred embodiments of the base member of the present invention, the base member comprises a rigid layer of glass bonded with cured PDMS to a PDMS layer formed from a complementary mould wherein the PDMS layer comprises a plurality of wells.

The devices of the present invention comprise a cover, usually in the form of a plate, overlying the base so as to define a headspace into which each well opens. The cover is preferably made of a substantially rigid material. Preferably the cover is in the form of a plate made of flat glass. The defined headspace may have a regular shape. Examples of regular shapes that may define the boundaries of the headspace include rectangular prisms (including square prisms) and cylinders (wherein the flat surfaces of the cylinder overly the wells). A preferred example of a regular shape is a rectangular prism. The headspace may also be irregular in shape. For example the headspace may have a shape that is a trapezoidal prism, such as would be defined when the internal face of a coverplate is not parallel to a surface created by joining the apertures of the wells on the base member. Another example of an irregular shape is a composite shape, an example of which is defined by the combination of a dome (which may correspond geometrically to less than half the surface of the corresponding sphere of the same curvature—such as in the case of a shallow dome) to a cylinder such that the deepest dimension of the composite shape overlies the approximate centre of the plurality of wells. Irregular shapes defining the headspace may also be especially preferred in certain embodiments of the invention where it is desirable to orientate the ‘deeper’ portion of the headspace proximal to an inlet and/or outlet.

In preferred embodiments of the present invention, the headspace entirely overlies not only the wells of the device but also entirely overlies the space between the wells of the device. The headspace preferably consists of a continuous region of space without division. In certain preferred embodiments, the region of space directly between that portion of the headspace directly above any two wells is not broken by any solid component of the device. Preferably the shortest fluid communication between the openings of any two wells is approximately equal in distance to the shortest distance in space between the apertures of those two wells. The defined headspace is preferably of such proportions (in particular is sufficiently small in volume) that application of the methods of the present invention results in the movement of a substantial proportion of the liquid in a reservoir into the wells, without substantial wastage of the liquid concomitantly evacuated or withdrawn from the headspace. On the other hand, the defined headspace is preferably of such proportions (in particular is sufficiently large in volume) that application of the methods of the present invention results in substantially no restriction of the flow of the liquid from the reservoir.

Another preferred feature of the devices of the present invention is that the headspace should preferably not be so small as to result in a substantial proportion of the liquid flowing from the reservoir into the headspace and subsequently evacuated from the headspace without the wells being substantially filled. In preferred embodiments of the present invention where the cover is in the form of a plate, the dimensions of the headspace are such that the distance between the opening of a well and the bottom of the well is approximately the same as the distance between the opening of the well and the coverplate.

The present invention is predicated in part on the discovery that the movement of liquid and/or gas into a headspace, which overlies a plurality of wells, is susceptible to the effects of design of the inlets and outlets which are in fluid communication with the headspace and wells. Such aspects of design contemplated by the present invention include the orientation, shape and size of the inlets, which are preferably in the form of channels. In some embodiments, the device comprises channels which are substantially cylindrical in shape. In other, more preferred embodiments, the channels of the devices of the present invention may have the shape of a rectangular prism (including square prism). The shapes of the channels of the present invention may be irregular. For example, the ends of the channels of the present invention may be rounded, or flared, to reduce so-called ‘edge-effects’. Accordingly the channels may comprise composite shapes. For example, a rectangular prism and a funnel shape may combine to produce the shape of a channel. Preferably, where the boundary of the headspace is substantially defined by a shape that has corners (eg a rectangular prism), the channels are located proximal to any two or more of the corners. In preferred embodiments of the invention, the boundary of the headspace is substantially defined by a rectangular prism (including square prism) shape. In those embodiments, the inlet and outlet channel(s) are each located proximal to a corner generated by the intersection of three faces of that rectangular prism. Without wishing to be bound by theory, in performing a method of the present invention, such an arrangement is believed to favour complete evacuation of the headspace subsequent to the substantial filling of the wells with a liquid.

The inlets and outlets can be provided in a suitable manner to provide means for the entry of liquid into the wells and, where appropriate, the removal of excess liquid from the headspace. In one embodiment the inlets and outlets may be in the form of channels formed in the base or in the cover member. The inlets and outlets may also be provided in a spacer which in some embodiments is located between the base and the cover member. The inlet(s) may be formed by a hole in the cover member. Each inlet or outlet of the present invention may be independently curved, angled or substantially straight. In some embodiments, the inlets and outlets are substantially straight. Where appropriate, the inlets and outlets are preferably orthogonal to the edge of the shape defining the boundary of the headspace to which the inlet or outlet is connected. Preferably, the inlets and outlets are arranged such that adjacent inlets and outlets are substantially orthogonal to each other. Without wishing to be bound by theory, it is believed that, during the performance of a method of the present invention, this arrangement promotes the substantial filling of the wells prior to the evacuation of a significant portion of the liquid from the headspace. Preferably, the cross-sectional areas of the inlets and outlets are greater for the inlet channels than for the outlet channels. Without wishing to be bound by theory, such an arrangement may allow a substantial filling of the wells prior to the evacuation of the headspace during the methods of the present invention. In especially preferred embodiments of the present invention, the device comprises a single inlet channel and three outlet channels. In such embodiments, the inlet channel has a rectangular prism shape, and the outlet channels have a composite shape—being the composite of a rectangular prism and a funnel shape, wherein the channel widens in aperture at the end of the channel proximal to the headspace.

The device according to the present invention includes at least one inlet, which in use, may be connected to a reservoir containing the liquid to be distributed. The reservoir will generally be connected to the inlet via a valve member which controls the passage of liquid and/or gas from the reservoir with the device. The reservoir will also generally have an aperture through which it is filled with liquid and through which gas, such as air or an inert gas such as nitrogen, may pass as liquid is removed from the reservoir through the open valve into the device. Operation of the valve may be manually controlled, for example with a tap, or automatically controlled, for example with an electrically controlled solenoid. Preferably, the outlet of the reservoir is coupled to a valve that provides a means for controlling the flow of the liquid and/or gas from the reservoir to the device. Such a means of controlling the flow of liquid and/or gas from the reservoir also provides that the pressure in the headspace and wells of the device may be reduced to a given pressure, prior to any liquid flowing from the reservoir to the wells. An example of a preferred reservoir is a vessel that is substantially open at the top and possesses a lower aperture which is coupled to a valve, the operation of said valve controlling wholly, or partially, the rate of flow out of the reservoir of liquid and/or gas that is/are contained in the reservoir. The reservoir and device are preferably coupled to each other. An example of a material that can provide such a coupling is a length of tubing. Preferably the tubing provides that all of the liquid that moves from the reservoir enters the inlet channel of the device. Preferably the external dimension of the tubing is approximately the same, or slightly smaller than, the internal dimension of the inlet channel. When the means of coupling the reservoir to the device is a length of tubing, a preferred means of restricting the flow of the liquid and/or gas from the reservoir to the device is a ‘pinch valve’.

The systems and apparatus of the present invention also provide a means for subjecting the wells to a pressure that is less than the pressure of the liquid at the outlet of the reservoir. An example of such a means is a pump that is capable of moving a fluid from one location to another. Such pumps may function through the movement of a liquid (eg water aspirator), by mechanical means (eg a diaphragm) or other means known to be suitable by a person skilled in the art. A preferred example of a means for subjecting the wells to a pressure that is less than the pressure of the liquid at the outlet of the reservoir is an oil-less vane vacuum pump. The systems of the present invention contemplate the pump being in fluidic communication with the headspace and wells of the device. Preferably the means of subjecting the wells to a pressure that is less than the pressure of the liquid at the outlet of the reservoir is capable of providing a pressure of less than 20 kPa, more preferably less than 15 kPa and most preferably between about 0.2 and 1.0 kPa within the wells of the device of the present invention. Preferably the system also provides a means of isolating the device of the invention from being in fluidic communication with the pump. An example of such a means is a valve. Operation of such a valve allows the potential maintenance of different pressures between the pump and the headspace of the device.

The systems of the present invention preferably comprise a housing, chamber or container in which the device may be located. Accordingly the housing will have larger dimensions than the device. Such a housing may be connected to the reservoir and to the means for subjecting the wells to a pressure less than the pressure at the outlet of the reservoir. Such a housing is preferably hermetically sealed or at least capable of being hermetically sealed. The systems and apparatus of the present invention contemplate that valve(s) provide an example of a means of operationally sealing and unsealing such containers. In this respect, the reservoir and means for reducing the pressure within the container may be integrated into the design of the container so that each component may be isolated from fluidic communication with each other component. Such containers are preferably capable of being readily opened to remove the device, and closed to seal the container. Such containers may comprise a support means for supporting the device. Preferably the support means raises the device off the lowest part of the container so that liquid may be irreversibly evacuated from the headspace of the device into the container whilst performing a method of the invention. Materials suitable for the construction of such containers include metal, glass, ceramic and plastic. Especially preferred materials for the construction of said containers are glass and substantially transparent plastics. An example of such a material is poly(acrylic acid), or a derivative thereof. Suitably, the containers may also comprise a seal made of a different material. The seal is preferably made of a flexible solid material, for example a polymer such as rubber. In preferred embodiments of the present invention, the system comprises a container that is capable of withstanding an internal pressure of about 0.2 kPa and a concurrent external pressure of about 101.3 kPa without substantial deformation.

The methods of the present invention are predicated, in part, on the discovery that the distribution of a liquid from a reservoir into a plurality of wells can be accomplished by applying a differential in pressure between the outlet of the reservoir and the wells such that there is an overall force applied to the liquid to effect that movement. Such division preferably allows the wells to substantially fill without residual ‘bubbles’ of gas remaining within the wells. Where the outlet of the reservoir is coupled to a means of regulating the flow of liquid and/or gas out of the reservoir, such as a valve, it is preferable that said means be closed initially so that the pressure within the headspace and wells may be reduced to below the pressure of the liquid at the outlet of the reservoir without any liquid exiting the reservoir. Accordingly the pressure within the wells of the device may be reduced so that when the means of regulating the flow of liquid and/or gas out of the reservoir is opened, the wells fill substantially with the liquid, without any residual portions of gas remaining within the wells. It is preferable to continue to subject the wells to a pressure that is less than the pressure of the liquid at the outlet of the reservoir whilst the wells are being filled. In this regard, the means of reducing the pressure within the headspace and wells of the device may continue to operate whilst liquid is flowing from the reservoir into the headspace and wells of the device. The reducing pressure means may also continue to operate after all of the liquid has exited the reservoir. Traditional methods of filling a well with a liquid, especially when the well is small in volume and/or the liquid is relatively viscous, can result in residual bubbles of gas remaining within the well. This is often an undesirable feature. The present invention provides that the wells of the device fill substantially with the liquid which is distributed from the reservoir. As used herein the expression ‘fill substantially’ may refer to any one well being filled substantially to its capacity, or that a substantial portion of the wells are filled or a combination of both meanings. It is understood that the forces on liquid and/or gas within spatially disparate wells are not the same. Accordingly it is possible that one or more wells may fill to a different level than another one or more wells. Whilst in preferred embodiments, the method of the present invention provides that the wells each fill to the same level, in other embodiments one or more of the wells may not fill to the same extent as one or more of the other wells.

The methods of the present invention also preferably provide that the distribution of a liquid into a plurality of wells results in any substance pre-loaded into a well of the device, prior to filling, not substantially transferring to another well within the device. The devices, systems and methods of the present invention are especially suited to applications wherein the wells of the device are pre-loaded with a plurality of different substances. In that case, it is often preferable that there be no transfer of a substance from one well into any of the other wells. Without wishing to be bound by theory it is understood that factors that influence whether the transfer of a substance from one well into any of the other wells will occur include: the rate of movement of the liquid into, and out of, the headspace; the degree of miscibility/solubility within the liquid of the substances in the wells; and the nature of any materials dissolved in the liquid. In certain embodiments, the method of the present invention preferably provides that the rate of movement of the liquid into, and out of, the headspace is sufficiently fast that the rate of diffusion of the substances into the liquid is negated. Preferably, the method of the invention provides that in one step the liquid moves into the headspace and wells, and in a subsequent step the liquid in the headspace is displaced by gas. In preferred embodiments of the method of the invention, the reservoir contains a quantity of liquid sufficient to substantially fill the headspace and wells of the device. In those embodiments, the liquid in the reservoir is drawn into the device under reduced pressure. Subsequently the reservoir, being drained of liquid, provides a source of gas that flows from the reservoir into the headspace of the device, thereby displacing the liquid from the headspace. In preferred embodiments, the headspace contains liquid for a minimal amount of time, such that there is substantially no transfer of a pre-loaded substance from one well into another well. Whilst the present invention may provide that the reservoir contains a volume of liquid greater than the combined volumes of the wells, it is also envisaged that the reservoir may contain a volume of liquid equal to, or even less than, the combined volumes of the wells. Furthermore, it is also envisaged that in performing the methods of the present invention the reservoir may not be allowed to completely drain of the liquid that is distributed into the wells, but rather that the headspace may remain filled with liquid for some time after the wells are initially filled. Such a method may be appropriate if the substances that may be preloaded into the wells are not susceptible to substantial diffusion or dissolution into the liquid, or perhaps that it is desired that the liquid in the headspace may be displaced with the sealant.

Preferably the method of the invention provides that the wells substantially fill with the liquid within a short space of time. Preferably, the wells are substantially filled in less than 1.0 s, more preferably within 0.5 s and most preferably within 0.3 s from when liquid first enters the head space.

It is understood that the pressure of the liquid at the outlet of the reservoir is dependent on a number of factors. Examples of such factors include the weight of the liquid within the reservoir; the shape of the reservoir; and the atmospheric pressure at the inlet of the reservoir. Preferably the pressure of the liquid at the outlet of the reservoir is approximately 101.3 kPa or greater. An example of a factor that influences the pressure within the device is the extent to which a vacuum is applied to the device. Such a vacuum may be applied for such a period of time so that the pressure is less than 20 kPa, preferably less than 15 kPa, most preferably between 0.2 and 1.0 kPa.

Whilst the devices, systems and methods of the present invention are especially suited to liquids of substantially the same viscosity as water, the invention may also be used with liquids that are of lower or higher viscosities. For liquids of lower and higher viscosities, the methods applied to the devices and systems of the present invention may utilise a different differential in pressure between the reservoir outlet and the headspace. For example, for liquids that are of lower viscosity than water, a pressure within the device of greater than 15 kPa may be appropriate. For example, for liquids that are of higher viscosity than water, a pressure within the device of less than 0.2 kPa may be appropriate. The present invention also provides for the division of liquids similar in viscosity to water but with modified surface tension. An example of such a liquid is water in which a surfactant has been dissolved. Such liquids may tend to foam upon contact with a gas. Accordingly, the invention provides that the pressure difference between the liquid at the outlet of the reservoir and the pressure within the device be such that such foaming does not prevent the liquid from substantially filling the wells before being evacuated from the headspace. The devices, systems and methods of the present invention are especially suited for application to the PCR. Accordingly, and as used herein, the term ‘liquid’ with reference to the liquid to substantially fill the wells may be used to describe substantially aqueous solutions, emulsions, or the like, comprising one or more of the following: DNA, RNA, cDNA, enzymes, fluorescent dye, dNTP, PCR mix.

The method of the present invention may also further comprise a step of sealing the fluidic communication between the wells of the device. Preferably such a step is performed after substantially filling the wells of the device. A liquid sealant may be distributed into the headspace. The liquid sealant may comprise such a material that it can be cured to a solid (such as a pre-polymer), or it may remain liquid (such as an oil). In preferred embodiments, the sealant may comprise PDMS prepolymer. It is understood that there are a number of means suitable for introducing the sealant into the headspace. One such means is a syringe, whereby a positive pressure is applied to the liquid sealant to force it into the headspace. In such embodiments, it is preferable that the pressure within the headspace be approximately the same as the pressure within the liquid sealant prior to exerting the positive pressure. Most preferably, the pressure within the headspace prior to sealing is in the range of 95 to 105 kPa, most preferably approximately 101.3 kPa. Another suitable means of delivering the sealant into the headspace is through layering the sealant on top of the liquid to be distributed into the wells, such that once all of the liquid for distribution into the wells has exited the reservoir, the sealant flows out of the reservoir and fills the headspace under the influence of the reducing pressure means. Such an effect may be achieved through careful regulation of the reducing pressure means. For example, once a portion of the sealant has exited the reservoir and filled the headspace, the reducing pressure means may be isolated from fluid communication with the headspace, accordingly no longer exerting any additional force upon the sealant within the headspace.

Preferably the cover of the device of the present invention may be removed from the base member following performance of a method of the invention. One reason for removing the cover is so that a sample may be taken from one or more of the wells of the device. In some embodiments of the present invention, where the headspace has been filled with a cured polymer, it may be necessary to pierce the polymer seal to remove a sample from the well. In such embodiments, a needle is a suitable item for piercing the polymer seal. The needle may be coupled to a syringe so as to withdraw a solution from the well.

### DETAILED DESCRIPTION OF THE INVENTION

The invention will now be described with reference to the drawings and some examples. It is to be understood that the particularity of the following description is not to supersede the generality of the preceding description of the invention.

Referring to the Figures:

### BRIEF DESCRIPTION OF THE DRAWINGS

FIG. 1 is a diagrammatic representation of a perspective view of the device of the present invention. As shown, the device comprises a cover, three outlets and one inlet channel, and 100 wells of substantially equal proportion, set about an array in a grid pattern.

FIG. 2 is a schematic representation of a cross-sectional side view of a device of the present invention, wherein a headspace is defined by a coverplate overlying the base.

FIG. 3 is a schematic representation of a cross-sectional side view of a system of the present invention.

FIG. 4 is a schematic representation of four steps (Step A to Step D) of a method according to the present invention.

FIG. 5 is a top view image sequence of the sample loading, well isolation and sealing process.

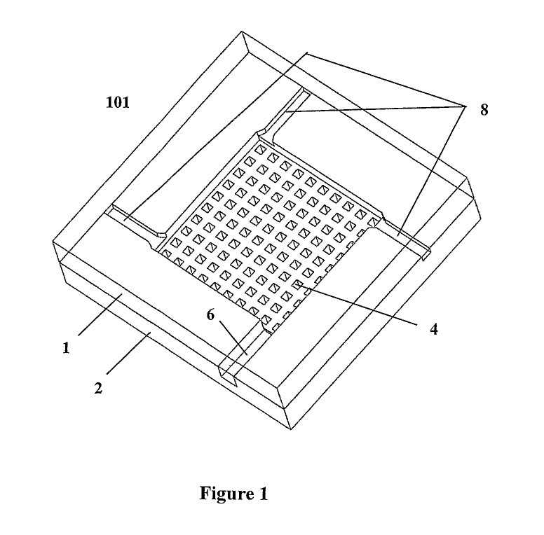

FIG. 1 is a diagrammatic representation of one embodiment of the device 101 of the present invention. In particular, the base member 2 comprises a plurality of wells 4 in the form of an array, an inlet channel 6 and three outlets 8. Each of the channels opens into the resin of the base member 4 occupied by the array of wells at a corner resin of the array, and each of the channels is orthogonal to the edge of the array through which each channel enters the array resin. In some embodiments of the device of the present invention, the height of the inlet 6 and/or outlet 8 channel may be less than the height of the space which overlies the wells. Preferably the cross-sectional area of the inlet channel 6 is greater than the respective cross-sectional area of the outlet channels 8. This relationship can be seen more clearly seen in FIG. 1. Furthermore, as can be seen in FIG. 1, the fluidic axis of each channel is offset with respect to the directing of entry or exit of the channel on the opposite edge of the device. Without wishing to be bound by theory, it is believed that this arrangement promotes the substantial filling of the wells prior to evacuation of the headspace during the methods of the present invention. FIG. 1 also shows a preferred distribution of the wells 4 across the base member 2.

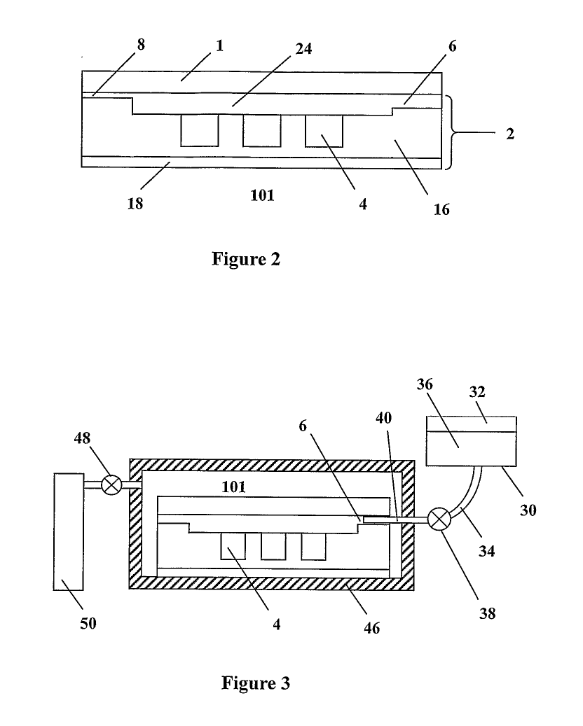

FIG. 2 is a schematic representation of a cross-section of a side view of a preferred embodiment of the device of the present invention. Although the inlet channel 6 and outlet channel 8 appear to be directly opposite in this representation, in the actual device represented the channels are offset as shown in FIG. 1. The representation is intended to show the layering of the components of this embodiment. In particular, FIG. 2 shows a composite base member that is formed between moulded polymeric member 16 and a glass plate 18. The composite so-formed is more rigid than member 16 itself. Into one or more of the wells 4 of the pre-fabricated polymeric chip may be loaded chemical and/or biological materials. The moulded polymeric member 16 and wells 4 may then be overlayed with a cover plate 1, thus defining a headspace. The inlet channel 6 allows for liquid to move into the headspace and wells from the space outside the device. The outlet channels 8 can be subjected to a vacuum source (not shown) to draw liquid into the headspace 24 and allow excess liquid to be removed from the headspace.

FIG. 3 is a schematic representation of a system of the present invention. Therein, a reservoir 30 comprising an inlet 32, an outlet 34 and containing liquid 36 is coupled to a valve 38. A length of tubing 40 couples the valve to the device 101 at inlet 6. The device 101 is situated within a housing 46 which is capable of allowing a substantial vacuum to form with it. The housing is coupled to a valve 48 which allows control over the fluidic communication between vacuum pump 50 and the housing 46. In use, vacuum pump 50 creates a region of reduced pressure within housing 46. This translates into a suction force which, when valve 38 is open, draws liquid 36 into device 101 through tubing 40 and inlet 6, and fill well 4. The reduced pressure is also capable of drawing excess liquid out of headspace 24.

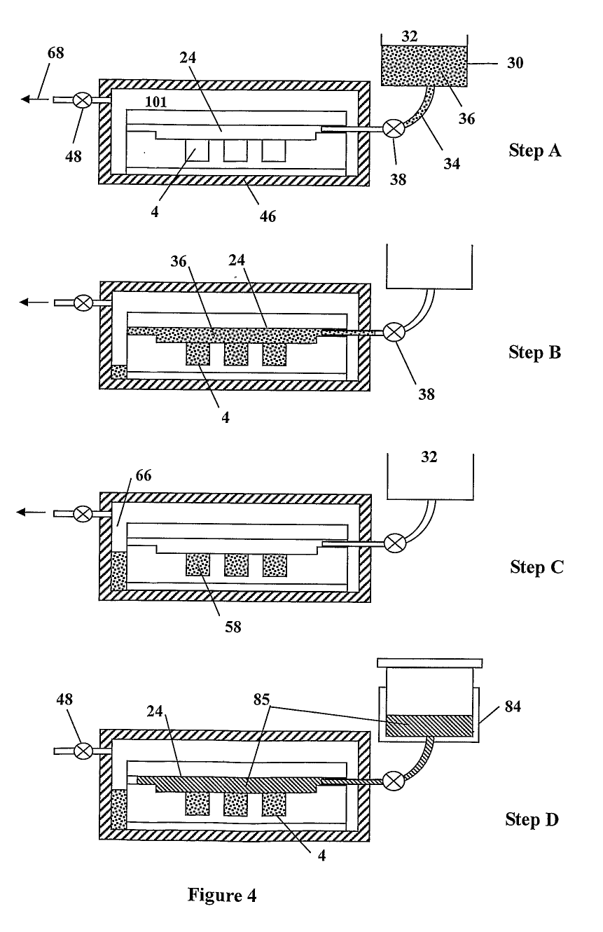

One embodiment of the method of the present invention is shown in FIG. 4. In Step A, the device 101, possessing wells 4 and a headspace 24, is contained within a housing 46. The device is coupled to a reservoir containing a liquid 36. The reservoir possesses an aperture (inlet) 32 at the vertical extreme of the reservoir, and an aperture (outlet) 34 coupled to a closed valve 38 capable of regulating the flow of liquid and/or gas out of the reservoir. The housing 46 is coupled to an outlet valve 48 which is used to regulate the pressure in the chamber which is altered by a vacuum 68. With valve 48 in the open position, and valve 38 in the closed position, the pressure in the housing is reduced to approximately between 0.2 and 1.0 kPa. In Step B, the valve 38 that regulates the flow of the liquid out of the reservoir is opened, allowing the liquid to move from the reservoir to fill the wells 4 and the headspace 24. In Step C, once the liquid has substantially drained from the reservoir, gas begins to move through the reservoir from the aperture 32, and through the open valve, thus entering the headspace of the device. The liquid 36 in the wells is not substantially affected by the movement of the gas into the headspace. The liquid that previously filled the headspace is evacuated into the chamber 66. In Step D, with the valve 48 in the closed position, the first reservoir is removed and replaced with a second reservoir 84 containing a material 85 suitable for acting as a sealant such as PDMS pre-polymer. Under a positive pressure, the sealant is forced from the second reservoir to the headspace 24. The device may be subsequently removed from the chamber and placed under such conditions, and for a period of time, sufficient to cause the sealant material to cure to a substantially solid material. In this way, the liquid in the wells 4 is protected from such deleterious effects as cross-contamination and evaporation during the thermal cycling of the device.

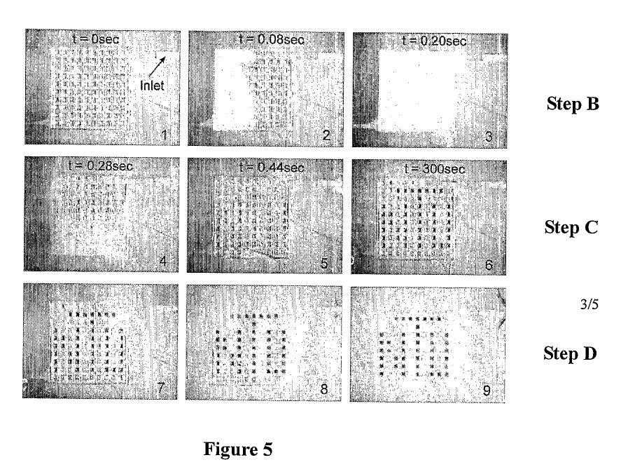

FIG. 5 shows a top view image sequence of the sample loading, well isolation and sealing process. Image frame 1-3 show the process of Step B, image frame 4-6 show the process of Step C, and image frame 7-9 show process Step D. The detailed description of each image frame is as follows: Frame 1: The chip was placed in the vacuum enclosure before PCR sample loading. Some of the wells were preloaded with blue dye dried on the well surface. Frame 2˜3: Driven by vacuum established in the headspace and wells, the sample liquid was injected into the headspace at high-speed and redistributed to fill the headspace and the wells in a fraction of a second after opening the pinch valve. Frame 4-5: Air followed the sample liquid immediately and purged the extra liquid out of the headspace through the venting channels, leaving all the wells isolated from each other in a fraction of a second. Afterwards, the vacuum was shut off. Frame 6: Resuspension of the dried dye gave the wells a blue colour, showing three blue characters, “NTU”, in the wells matrix, while the rest of the wells remained clear. This shows that there is no visible cross-contamination among the wells. Frame 7˜9: The sealant (PDMS prepolymer) was injected into the headspace from the tubing and all the wells were sealed.

### EXAMPLES

### Example 1

### Construction of a Device for PCR

An example of a device with the largest face measuring 5×5 cm, and possessing 100 wells each of dimensions 0.5×0.5×0.5 mm, was prepared as follows. Liquid prepolymer (2 mL) was prepared by mixing 10 parts PDMS Sylgard Silicone Elastomer 184 and 1 part Sylgard Curing Agent 184 (Dow Corning Corporation Midland, Mich., USA) to homogeneity with a magnetic stirrer at 150 rpm for 1 hour in a beaker. The PDMS prepolymer was applied to the surface of a metal die (micro EDM machined stainless steel) with reversed shape of the wells and channels, and the liquid prepolymer degassed under vacuum for 20 minutes. Subsequently, another metal block with a flat surface was placed on top of the PDMS prepolymer and the entire assembly was heated to 80° C. for 2 hours. The PDMS replica layer with nanowells and microchannels was carefully removed from the mould and the flat surface of the polymer subsequently bonded to a 0.1 mm thick acid-washed borosilicate glass substrate (Herenz Medizinalbedarf, Hamburg, Germany) using a 2 μm thick spin-coated layer of liquid PDMS as an adhesive layer. The assembly, with adhesive layer, was cured at 80° C. for 2 hours to permanently bond the PDMS layer to the glass substrate.

A number of the wells were manually loaded with primer liquor containing nucleic acid primer pairs for PCR analysis of multiple genes. The device was then heated to 80° C. for 10 mins, evaporating a substantial portion of the water from the preloaded primer liquor inside the wells. The primer sets can also be dried by a freeze drying process or at room temperature. Finally, a 0.1 mm thick acid-washed borosilicate glass cover plate (Herenz Medizinalbedarf, Hamburg, Germany) was placed over the wells and bonded to the PDMS matrix chip using liquid PDMS to define a headspace and form enclosed microchannels.

### Example 2

### Cross-Contamination

It has been demonstrated that during the process of substantially filling the wells, there is negligible cross-contamination of chemical substances preloaded into the wells. In this respect a predetermined number of wells within a device comprising 100 equal volume wells were preloaded with a solution containing a blue dye. The solvent was subsequently evaporated from the wells of the device. Driven by a vacuum according to a method of the present invention, the wells and headspace were filled with a liquid which was a suitable solvent for the blue dye, before the headspace was appropriately evacuated. It was observed that essentially all of the blue dye remained in each of the wells into which it had been preloaded.

To further validate the finding of negligible cross-contamination, a select number of wells of another device were preloaded with a solution of purified 20 mer long oligonucleotides (primers) tagged with FAM fluorophore (5′-(6 FAM)-TCG TGC GTG GAT TGG CTT TG). The solvent was then evaporated. According to a method of the present invention, the wells were filled with a PCR mixture containing 10 mM Tris-HCl (pH 8.4), 50 mM KCl, 0.1% Triton X-100, 0.2 mM each of dATP, dCTP, dTTP and dGTP, 3 mM MgCl₂, 0.2 UμL of Taq DNA polymerase (Promega, Madison, USA) and 0.01 ng/μL of SARS DNA cloned in pGEM-3Z vector as template. Using a fluorescence microscope setup, it was observed that not only was there no observable movement of tagged oligonucleotide from the preloaded wells to the wells that were not preloaded, but that the rate of diffusion of the tagged oligonucleotide was also slow. Moreover, after 279 s at room temperature, the tagged oligonucleotide had not diffused into the total volume of the solution in the well.

### Example 3

### Real-Time PCR Method

The devices, systems and methods of the present invention have been applied to the field of real-time PCR. Twenty-two wells of a device of the present invention comprising a total of 100 wells were preloaded with solutions containing primers pairs, leaving the remaining 78 wells empty. The solvent was subsequently evaporated leaving dried primer pairs. The sequences of forward and reverse primers were 5′-ATG AAT TAC CAA GTC AAT GGT TAC-3′ (24 mer) and 5′-CAT AAC CAG TCG GTA CAG CTA-3′ (21 mer). The wells of the device were filled with PCR mixture containing a fixed concentration of DNA template using a method of the present invention. The PCR mixture contained 10 mM Tris-HCl (pH 8.4), 50 mM KC1, 0.1% Triton X-100, 0.2 mM each of dATP, dCTP, dTTP and dGTP, 3 mM MgCl₂ 0.2 U/μL of Taq DNA polymerase (Promega, Madison, USA), 1.5 μg/μL BSA, 2×SYBR Green I (Cambrex Biosciences, Maine, USA) and 0.01 ng/μL of the BNI-1 fragment (189 bp) of SARS DNA cloned in pGEM-3Z vector as a template. The PCR mixture dissolved the dried primer pairs, giving a final concentration of 0.3 μM each of forward and reverse primer. The headspace of the device was subsequently filled with liquid PDMS in turn removing the fluid communication between the wells of the device.

The device was then thermally cycled using a thermoelectric heater/cooler (TEC) (Melcor Corp., Trenton, N.J., USA) which was coupled to the device. A RTD (Resistive Temperature Detector) was mounted on the TEC to measure the temperature and used for the feedback control. The following thermal cycling profile was used: initial denaturation at 95° C. for 60 seconds followed by 40 cycles of denaturation at 95° C. for 15 seconds, annealing at 60° C. for 15 seconds and extension at 72° C. for 15 seconds. The optics of the real-time PCR instrument was designed to measure the fluorescence of SYBR Green I, a DNA intercalating dye, and the fluorescence of SYBR Green I dye was measured at the extension step of every PCR cycle. The SYBR Green I fluorophore was excited using an array of blue LED (Marl International Ltd, Cumbria, UK) and fixed at an angle of 45° to the plane of the PCR device to prevent interference of the excitation light on the light path of the detection unit. Both the excitation light (intensity peak at 480 nm) from blue LED array and the emission light from the chip were filtered using a bandpass filter of 465-495 nm and 515-555 nm (Chroma Technologies Corp, Brattleboro, USA), respectively. The fluorescence image of the entire chip was captured by a cooled CCD camera (DTA, Pisa, Italy). The threshold cycle (Ct) for amplification of 3×10⁷ copies of templates from 22 wells in the PDMS device was determined to be approximately 11 cycles. The Ct values for amplification of 3×10⁷ copies of template DNA in 22 wells were consistent across the chip.

The reference in this specification to any prior publipation (or information derived from it), or to any matter which is know, is not, and should not be taken as an acknowledgement or admission or any form of suggestion that that prior publication (or information derived from it) or know matter forms part of the common general knowledge in the field of endeavour to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1. A device for distributing a liquid into a plurality of wells, the device comprising:
a) a base having a plurality of wells;
b) a cover overlying the base so as to define a headspace above the wells into which the wells open;
c) at least one inlet for feeding the liquid into the headspace for distribution of the liquid into the wells; and
d) at least one outlet for communication with the headspace for removal of excess liquid from the headspace and for communication with the headspace for application of a reduced pressure to the headspace.

2. The device according to claim 1 wherein the configuration of the device is such that the application of a reduced pressure to the or each outlet acts to withdraw excess liquid from the headspace.

3. The device according to claim 1, wherein the base comprises a plurality of elements.

4. The device according to claim 3 wherein the base is constructed of a polymeric material and a substantially rigid material.

5-6. (canceled)

7. The device according to claim 1, wherein the cover is composed of a substantially rigid material.

8-11. (canceled)

12. The device according to claim 1, wherein at least one of the wells of the device are preloaded with one or more substances prior to locating the cover plate over the base.

13. The device according to claim 12 wherein the substance is a chemical or biological compound.

14. (canceled)

15. The device according to claim 1 wherein the device is constructed so as to allow light to enter and exit the wells.

16-17. (canceled)

18. The device according to claim 1 for use in the Polymerase Chain Reaction (PCR)₅ wherein two or more of the wells are preloaded with different nucleic acid primer pairs and wherein the liquid to be distributed comprises nucleic acid such as a DNA template.

19. A system for distributing a liquid into a plurality of wells comprising:
a) a base having a plurality of wells;
b) a cover overlying the base so as to define a headspace above the wells into which the wells open;
c) at least one inlet for feeding the liquid into the headspace for distribution of the liquid into the wells; and
d) at least one outlet for communication with the headspace for removal of excess liquid from the headspace and for communication with the headspace for application of a reduced pressure to the headspace;
e) a reservoir containing liquid to be distributed, the reservoir being connected to at least one inlet via a valve means for controlling the flow of liquid from the reservoir to the headspace; and
f) a means for applying reduced pressure to at least one outlet.

20. The system according to claim 19 further comprising a housing for the device which is adapted to be sealed.

21. The system according to claim 19, wherein the reservoir has an inlet which is substantially open to the atmosphere.

22. The system according to claim 19, wherein the means for applying reduced pressure comprises a pump.

23. The system according to claim 19 further comprising a means of injecting a second liquid into the headspace of the device after the wells have been substantially filled with the liquid contained in the reservoir and excess liquid has been removed through at least one outlet.

24. The system according to claim 23 wherein the second liquid acts to seal the liquid in the respective wells.

25. (canceled)

26. The system of claim 19 further comprising:
g) applying reduced pressure to at least one outlet such that liquid is drawn through at least one inlet into the headspace for distribution into the wells.

27. A method for distributing a liquid into a plurality of wells comprising:
a) applying reduced pressure to at least one outlet such that the pressure within the headspace and wells of the device is less than the pressure of the liquid at the outlet of the reservoir;
b) opening the valve means such that the liquid within the reservoir exits the reservoir and enters the headspace and wells of the device; and
c) isolating the means of reducing the pressure within the headspace and wells of the device from fluid communication with the headspace and wells of the device.

28. The method according to claim 27 further comprising the step after b) wherein excess liquid is withdrawn from the headspace under the influence of the reduced pressure means.

29. The method according to claim 27 further comprising the step after b) wherein gas is allowed to flow from the reservoir into the headspace of the device under the influence of the reduced pressure means.

30. The method according to claim 27, further comprising the steps of:
d) coupling to inlet of the device a reservoir containing a liquid sealant; and
e) applying a pressure to the liquid sealant such that it flows from the reservoir to the headspace of the device.

31-33. (canceled)
